(19) United States
(12) Patent Application Publication
(10) Pub. No.: US 2011/0055027 A1
(43) Pub. Date: Mar. 3, 2011

(54) COOKING ASSISTANCE TERMINAL, WEARABLE COOKING ASSITANCE TERMINAL AND METHOD

(75) Inventors: Katsuyuki Suzuki, Shizuoka (JP); Hitoshi Iizaka, Shizuoka (JP); Nobuyuki Marumo, Shizuoka (JP); Shin Yoshimune, Kanagawa (JP); Morito Natsume, Tokyo (JP); Yasuhiko Mochida, Shizuoka (JP); Nobuo Watanabe, Shizuoka (JP)

(73) Assignee: TOSHIBA TEC KABUSHIKI KAISHA, Tokyo (JP)

(21) Appl. No.: 12/841,230

(22) Filed: Jul. 22, 2010

(30) Foreign Application Priority Data
Aug. 25, 2009 (JP) 2009-194052

(51) Int. Cl. G06Q 50/00; G06Q 10/00; G10L 11/00

(52) U.S. Cl. 705/15; 704/275; 704/E11.001

(57) ABSTRACT

A cooking assistance terminal includes a display unit and an acceptance unit. The display unit displays a list of ordered items included in order information from a customer. The acceptance unit accepts a selection command to select an ordered item with cooking completed, from the ordered items displayed in the list. The display unit also displays the ordered item on which the selection command is given, identifiably from the other ordered items, as an ordered item that is already cooked.

### CROSS-REFERENCE TO RELATED APPLICATION

This application is based upon and claims the benefit of priority from Japanese Patent Application No. 2009-194052 filed on Aug. 25, 2009, the entire contents of which are incorporated herein by reference.

### FIELD

An embodiment of the present invention relates to a cooking assistance terminal, a wearable cooking assistance terminal and method.

### BACKGROUND

Conventionally, a cooking assistance terminal is known which outputs order information about an order received from a customer. A cook who uses this cooking assistance terminal confirms the outputted order information and thus can cook an ordered item. JP-A-2001-76048 is known as a conventional technique for outputting this order information about a received order. JP-A-2001-76048 discloses an order management system which receives order information from a customer and prints cooking instruction information and food service instruction information.

However, with the conventional technique, it is difficult to differentiate an ordered item that is not cooked yet and an ordered item that is already cooked, in the outputted order information. Therefore, a cook who carries out cooking based on the outputted order information finds it difficult to determine which ordered item to be cooked next.

### BRIEF DESCRIPTION OF THE DRAWINGS

FIG. 1 shows an example of an order system according to an embodiment.

FIG. 2 shows an example of a head mount display according to the embodiment.

FIG. 3 is a ladder chart showing an example of operation of the order system according to the embodiment.

FIG. 4 shows an example of display on a monitor display unit.

FIG. 5 shows an example of display on the monitor display unit.

FIG. 6 is a flowchart showing processing by a wearable cooking assistance terminal according to the embodiment.

FIG. 7 shows an example of display on a monitor display unit.

### DETAILED DESCRIPTION

According to an embodiment, a cooking assistance terminal includes a display unit and an acceptance unit. The display unit displays a list of ordered items included in order information from a customer. The acceptance unit accepts a selection command to select an ordered item with cooking completed, from the ordered items displayed in the list. The display unit also displays the ordered item on which the selection command is given, identifiably from the other ordered items, as an ordered item that is already cooked.

According to another embodiment, a wearable cooking assistance terminal includes a head mount display and an acceptance unit. The head mount display has a monitor display unit which displays a list of ordered items included in order information from a customer. The acceptance unit accepts a selection command to select an ordered item with cooking completed, from the ordered items displayed in the list, from a wearer of the head mount display. The monitor display unit displays the ordered item on which the selection command is given, identifiably from the other ordered items, as an ordered item that is already cooked.

According to still another embodiment, a method for controlling a cooking assistance terminal includes displaying a list of ordered items included in order information from a customer. The method also includes accepting a selection command to select an ordered item with cooking completed, from the ordered items displayed in the list. The method also includes displaying the ordered item on which the selection command is given, identifiably from the other ordered items, as an ordered item that is already cooked.

Hereinafter, an embodiment of a cooking assistance terminal and a wearable cooking assistance terminal and method will be described in detail with reference to the attached drawings. In this embodiment, a case where a wearable cooking assistance terminal is applied to a user interface used by a cook in an order system at a restaurant or the like will be described.

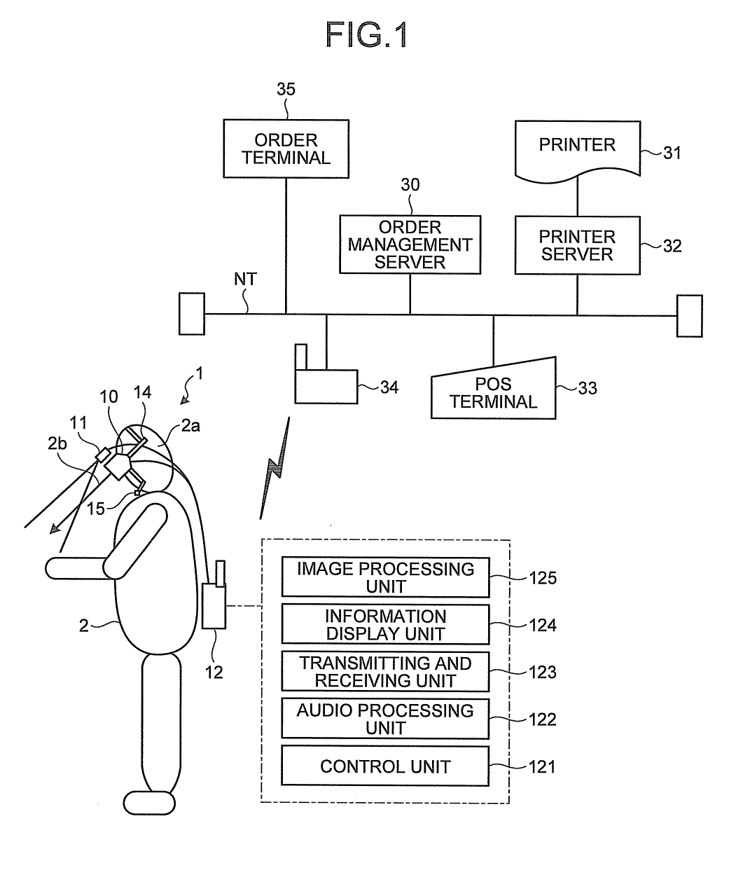

FIG. 1 shows an example of an order system according to this embodiment. As shown in FIG. 1, the order system has a wearable cooking assistance terminal 1, an order management server 30, a printer server 32, a transmitting and receiving device 34, and an order terminal 35. The wearable cooking assistance terminal 1 is a user interface worn and used by a wearer 2 that is a cook. The order management server 30 manages orders from the order terminal 35. The printer server 32 controls a printer 31 for printing various slips (for example, order slips). The transmitting and receiving device 34 transmits and receives data to and from the wearable cooking assistance terminal 1. The order terminal 35 is used by a sales assistant such as a waiter or waitress to accept an order from a customer. The wearable cooking assistance terminal 1, the order management server 30, the printer server 32, the transmitting and receiving device 34 and the order terminal 35 are connected via a network NT. The network NT is a LAN (local area network), intranet, Ethernet (trademark registered) or the like.

The transmission and reception of data between the transmitting and receiving device 34 and the wearable cooking assistance terminal 1 may be carried out via radio waves, light, infrared rays, ultrasonic waves or the like. In this embodiment, near field wireless communication having a communication range of approximately several meters (for example, Bluetooth (trademark registered)) is used. More than the one transmitting and receiving devices 34 are provided in order to cover the entire area within the store (for example, near the checkout counter, on the floor where the customer table is provided, in the backyard and so on). The transmitting and receiving device 34 may also transmit and receive data to and from the order terminal 35. The order terminal 35 need not be connected to the network NT via a cable.

The order management server 30 manages an order of food inputted on the order terminal 35 by the sales assistant. Specifically, the order management server 30 allocates a unique order number to order information which the order management server 30 is notified of from the order terminal 35, then stores the order information with the order number in an internal storage or the like, and thus registers the order information. The order information includes the customer table where the order is accepted, the number of customers, ordered items, the number of items ordered, and the like. The order information registered in the order management server 30 is printed together with the order number in the form of an order slip by the printer 31. This order slip is to be used at the time of checkout at a POS terminal 33 and is handed to the customer, for example, after food is served. The order management server 30 also notifies the wearable cooking assistance terminal 1 of the registered order information and distributes various kinds of information to the order terminal 35 (which will be described later in detail).

The POS terminal 33 has a drawer, a key input unit, a scanner, a card reader, a display, a receipt and journal printer, and the like (none of which is shown). The POS terminal 33 is to carry out commercial transactions using cash or credit card and is provided, for example, on the checkout counter or the like. For example, the POS terminal 33 accepts an order number printed on an order slip via key input or scanning by the scanner, and acquires order information corresponding to that order number from the order management server 30. The POS terminal 33 reads out a master file in which an identification code and price is preset for each food item (menu item), from an internal ROM (read only memory) or a data server (not shown), and carries out checkout of the order according to the acquired order information.

The order terminal 35 is an information terminal to be used by a sales assistant. The order terminal 35 has a display such as an LCD (liquid crystal display), an operation input unit such as a touch panel to accept operation inputs, and so on. The order terminal 35 accepts an order from a customer via the operation input unit and displays information distributed from the order management server 30 on the display.

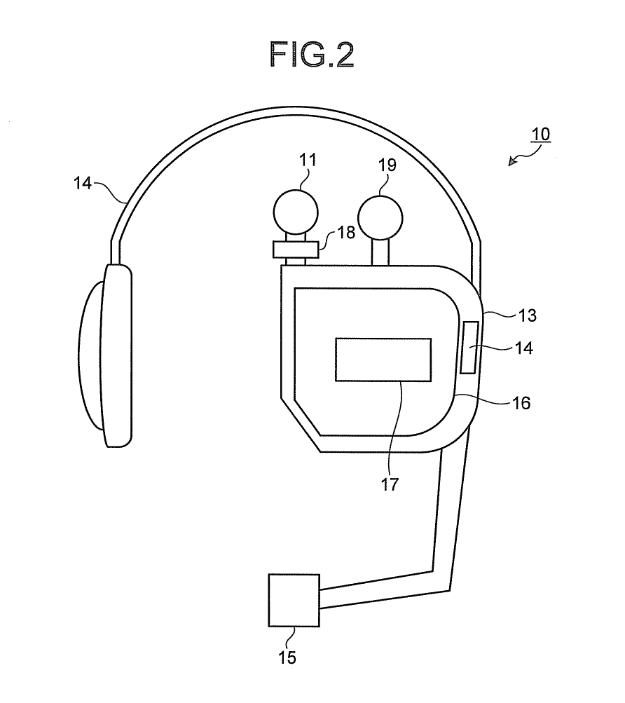

The wearable cooking assistance terminal 1 is an information terminal worn and used by the wearer 2 (cook) and has a head mount display 10, a digital camera 11 as an image pickup device, an interface box 12, and a microphone 15. As shown in FIG. 2, the head mount display 10 has a frame 13 to hold a light transmitting member 16 having a monitor display unit 17, and a headphone-type wearing arm 14 to arrange the frame 13 in front of the left eye of the wearer 2. That is, the head mount display 10 is worn by the wearer 2 with the wearing arm 14 placed on the wearer's head 2a. In the state where the head mount display 10 is worn, the frame 13 is arranged in front of the left eye of the wearer 2.

The frame 13 is formed in a shape having a size that matches the left eye of the wearer 2. At an upper part outside of the frame 13, the digital camera 11 is provided via an image pickup direction varying mechanism 18. Outside of the frame 13, a line-of-sight recognition camera 19 is provided which picks up an image of the pupil of the wearer 2 and detects a line of sight 2b (the position of the line of sight). Below the frame 13, the microphone 15 is provided which picks up the voice of the wearer 2 and sound in the surroundings. Within the frame 13, the plate-like light transmitting member 16 that is formed, for example, in accordance with the shape of the frame, is held. The light transmitting member 16 may be, for example, colorless and transparent or may be in a predetermined color. The light transmitting member 16 enables the eye of the wearer 2 to observe the surrounding environment.

The monitor display unit 17 is formed at a part within the light transmitting member 16. The monitor display unit 17 shows a monitor display of, for example, image data of dynamic images acquired via image pickup by the digital camera 11 and various kinds of information in real time. Therefore, the monitor display can be shown to the left eye of the wearer 2 in the state where the wearer 2 is wearing the head mount display 10. The monitor display unit 17 shows the monitor display in the light transmitting state. Thus, the monitor display unit 17 enables the wearer to observe the surrounding environment even in the state where the monitor display is shown in real time. For example, with the wearable cooking assistance terminal 1, the cook can confirm the monitor display while cooking.

In this embodiment, the configuration in which the frame 13 is arranged in front of the left eye of the wearer 2 to show the monitor display to the left eye of the wearer 2 is described as an example. However, the monitor display to the wearer 2 may be shown to the right eye or both eyes. For example, if the frame 13 is arranged in front of the right eye of the wearer 2, the monitor display is shown to the right eye of the wearer 2.

The digital camera 11 picks up images and outputs image data of dynamic images. The digital camera 11 is attached on the frame 13 of the head mount display 10, with its image pickup range set in such a manner that the focus is aligned with the direction of the line of sight 2b of the wearer 2 via the light transmitting member 16. The image pickup direction varying mechanism 18 supports the digital camera 11, for example, in a way that allows the digital camera 11 to swing. Thus, the image pickup direction of the digital camera 11 is set in an arbitrary direction. Here, the image pickup range of the digital camera 11 is set in such a manner that the focus is aligned with the direction of the line of sight 2b of the wearer 2.

The interface box 12 transmits and receives data to and from the transmitting and receiving device 34 and carries out various kinds of processing with respect to the head mount display 10. Specifically, the interface box 12 has a control unit 121, an audio processing unit 122, a transmitting and receiving unit 123, an information display unit 124, and an image processing unit 125. The interface box 12 is a box that be carried by the wearer 2. The control unit 121 is a computer having a CPU (central processing unit), a RAM (random access memory), a ROM and the like. The control unit 121 controls operations of the wearable cooking assistance terminal 1. In the ROM, a program and various kinds of setting information that is referred to at the time of executing the program are stored. The CPU unfolds the program stored in the ROM into a work area in the RAM, then sequentially executes the program, and thus centrally controls operations of the wearable cooking assistance terminal 1. The functions of the units including the image processing unit 125, the information display unit 124, the transmitting and receiving unit 123, the audio processing unit 122 and the like in the interface box 12 may also be realized by means of the control unit 121 by execution of a program that is stored in the ROM in advance.

The audio processing unit 122 carries out processing such as recognition of audios inputted via the microphone 15. Specifically, the audio processing unit 122 collates audio data included in a preset dictionary data with audio data from the microphone 15 and thus recognizes a predetermined audio command. Next, the audio processing unit 122 notifies the control unit 121 of the recognized audio command. The control unit 121 carries out processing corresponding to the audio command which the control unit 121 is notified of. Thus, the wearable cooking assistance terminal 1 can be operated in response to an audio command vocalized by the wearer 2. Hereinafter, the operation of the wearable cooking assistance terminal 1 in response to the above audio command is called audio operation. The acceptance of the audio operation from the wearer 2 by the wearable cooking assistance terminal 1 saves the wearer 2 from carrying out manual input. This audio operation is effective particularly when the wearer 2 is cooking.

The information display unit 124 displays image data inputted from the control unit 121 or the like, on the monitor display unit 17 of the head mount display 10. The information display unit 124 also displays various images including an information window and icons at predetermined coordinates on the monitor display unit 17 under the control of the control unit 121.

The image processing unit 125 carries out image processing of image data acquired through image pickup by the digital camera 11, and also analyzes image data picked up by the line-of-sight recognition camera 19 and thus detects the line of sight 2b of the wearer 2. Specifically, the image processing unit 125 detects the pupil of the wearer 2 from image data picked up by the line-of-sight recognition camera 19. Then, the image processing unit 125 detects the line of sight 2b in accordance with the position of the detected pupil. The result of the detection of the line of sight 2b is outputted to the information display unit 124. The information display unit 124 displays an order display window at coordinates on the monitor display unit 17 corresponding to the result of the detection of the line of sight 2b outputted from the image processing unit 125.

The input operation at the wearable cooking assistance terminal 1 may also be carried out in accordance with the line of sight 2b detected by the image processing unit 125 on the basis of the image from the line-of-sight recognition camera 19 under the control of the control unit 121. Specifically, as the information display unit 124 detects the line of sight 2b when the wearer 2 looks at an icon image for operation input displayed on the monitor display unit 17, the input operation at the wearable cooking assistance terminal 1 is carried out. For example, if an icon image displayed at predetermined coordinates on the monitor display unit 17 and the order display window based on the result of the detection of the line of sight 2b overlaps each other, the input operation corresponding to the icon image is accepted. Hereinafter, the input operation at the wearable cooking assistance terminal 1 corresponding to the line of sight 2b is called eye-controlled operation. The acceptance of the eye-controller operation from the wearer 2 by the wearable cooking assistance terminal 1 saves the wearer 2 from carrying out manual input. This eye-controlled operation is effective particularly when the wearer 2 is cooking.

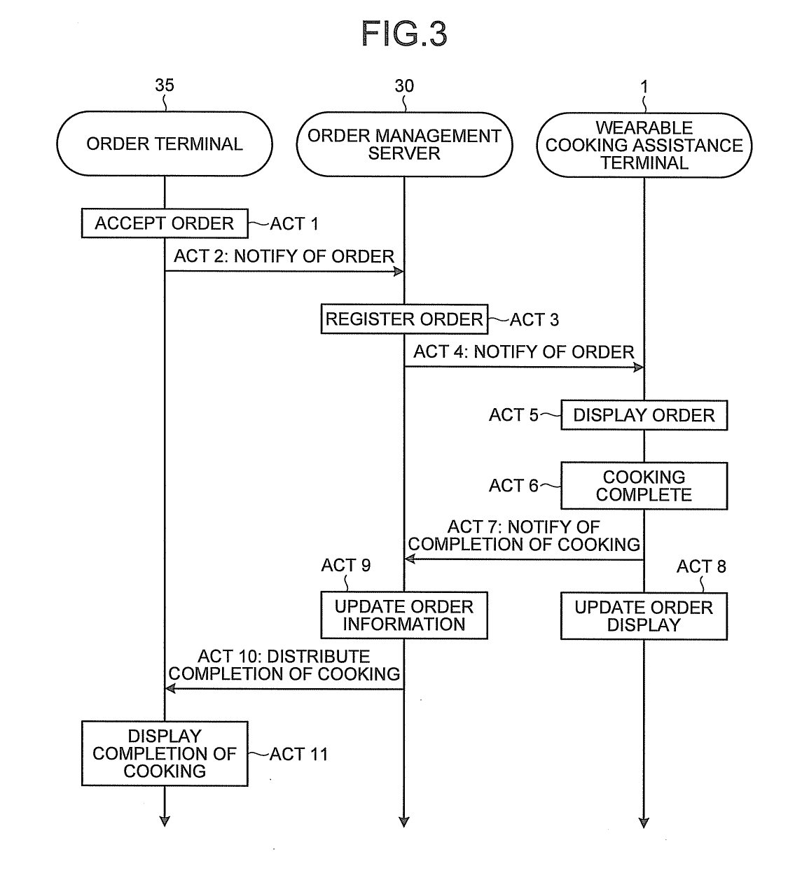

Next, the operation of the order system according this embodiment will be described. FIG. 3 is a ladder chart showing an example of the operation of the order system according to the embodiment.

As shown in FIG. 3, the order terminal 35 accepts an order input including the customer table where the order is accepted, the number of customers, ordered items, the number of items ordered and the like (ACT 1). Next, the order terminal 35 notifies the order management server 30 of the accepted order as order information (ACT 2).

The order management server 30 registers the order information which the order management server 30 is notified of from the order terminal 35 (ACT 3). Next, the order management server 30 notifies the wearable cooking assistance terminal 1 of the registered order information and its order number (ACT 4). The wearable cooking assistance terminal 1 displays the order information which the wearable cooking assistance terminal 1 is notified of from the order management server 30, on the monitor display unit 17 (ACT 5).

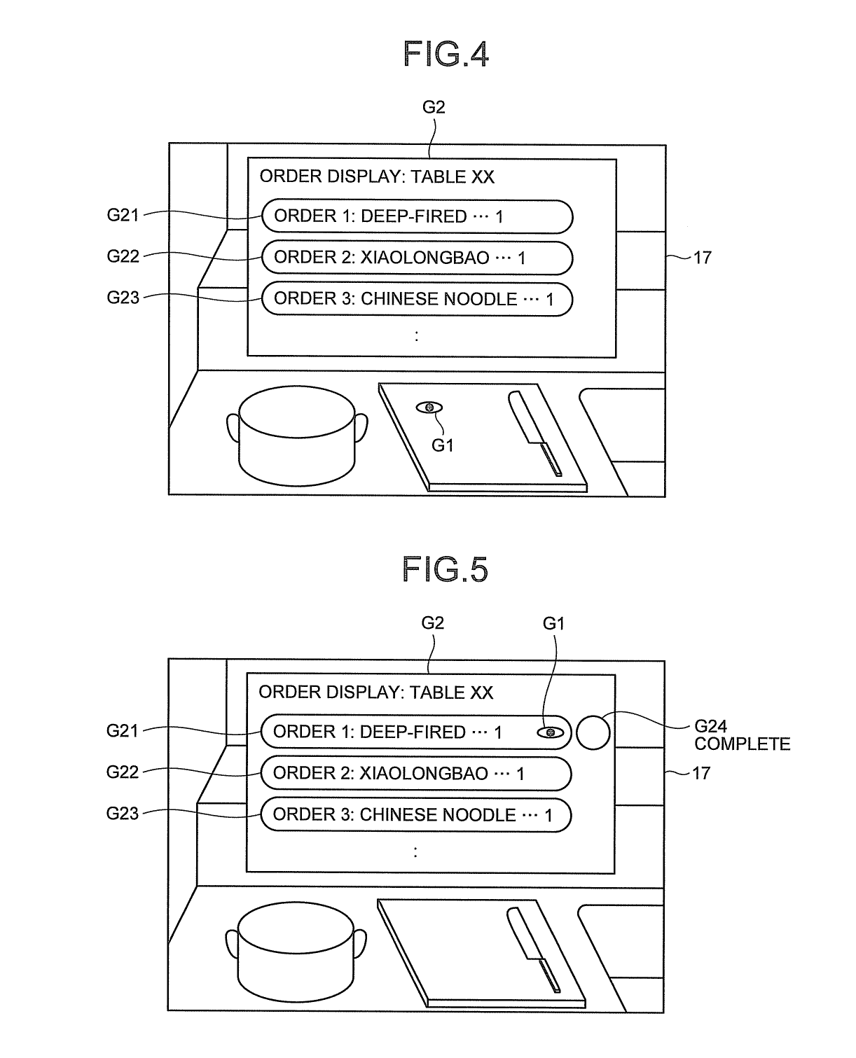

FIG. 4 shows an example of display on the monitor display unit 17. More specifically, FIG. 4 shows an example of display of the order information that is notified of from the order management server 30. In FIG. 4, a line of sight marker G1 is a marker displayed on the monitor display unit 17 in accordance with the result of the detection of the line of sight 2b. An order display window G2 is a display window to display a list of ordered items included in the order information that is notified of. As shown in FIG. 4, in ACT 5, the order information that is notified of from the order management server 30 is displayed in the order display window G2. Specifically, order icons G21 to G23 corresponding to ordered items included in the order information are displayed in the order display window G2. Thus, the cook can start cooking each ordered item included in the order information.

When the cooking of an ordered item included the order information displayed on the monitor display unit 17 is completed, the cook inputs the completion of cooking by audio operation or eye-controlled operation (ACT 6). Specifically, in the case of audio operation, the audio processing unit 122 identifies a predetermined word corresponding to the dictionary data on the basis of an audio input and identifies a word or sentence that indicates the completion of cooking, thereby accepting the completion of cooking of the ordered item displayed in the order display window G2. For example, on the basis of an audio input such as “order 1, deep-fried, complete”, the completion of cooking of an ordered item indicated by the order icon G21, which corresponds to the audio content, is accepted. Meanwhile, in the case of eye-controlled operation, if the wearer 2 looks at a selected order icon and the image processing unit 125 detects that the line of sight marker G1 overlaps the order icon for a predetermined time, the selection of the order icon is accepted. Thus, the completion of cooking of the ordered item displayed in the order display window G2 is accepted. For example, if it is detected that the line of sight marker G1 overlaps the order icon G21 for a predetermined time, the completion of cooking of the order item indicated by the order icon G21 is accepted.

In response to the input of the completion of cooking, the wearable cooking assistance terminal 1 notifies the order management server 30 of the completion of cooking of the ordered item for which the above input is given (ACT 7). Specifically, the wearable cooking assistance terminal 1 notifies the order management server 30 of the order number and the ordered item of the order information to which a flag indicating the completion of cooking is attached. The wearable cooking assistance terminal 1 also displays the ordered item to which the input of the completion of cooking is given, with information indicating the completion of cooking, and thus updates the display of the order information on the monitor display unit 17 (ACT 8).

FIG. 5 shows an example of display on the monitor display unit 17. More specifically, FIG. 5 shows an example of display on the monitor display unit 17 after the display of the order information is updated in ACT 8. As shown in FIG. 5, a cooking completion icon G24 indicating the completion of cooking of the ordered item for which the completion of cooking is inputted is attached in ACT 8, and this ordered item is thus differentiated from other ordered items. Thus, the cook can confirm which ordered item is already cooked and which ordered item should be cooked (which ordered item is not cooked yet).

The display layout shown in FIG. 5 is only an example and the display layout is not particularly limited to the illustrated example as long as an ordered item with cooking completed can be identified from among ordered items displayed on the monitor display unit 17. For example, display forms including color, density, shading and the like may be changed to enable differentiation between an order icon indicating an ordered item with cooking completed and other order icons. Alternatively, an ordered item with cooking completed may be erased from the display on the monitor display unit 17, and for differentiation from other ordered items, the ordered item with cooking completed may be erased from the display.

On accepting the notification of the completion of cooking, the order management server 30 attaches information indicating that the ordered item is already cooked, to the registered ordered item of the order information and thus updates the order information (ACT 9). Next, the order management server 30 distributes the notification of the completion of cooking to the order terminal 35 (ACT 10). On accepting the distributed notification of the completion of cooking, the order terminal 35 shows the completion of cooking on the display (ACT 11). Specifically, on the display of the order terminal 35, the ordered item for which the completion of cooking is inputted by the cook is shown as already cooked. Thus, the sales assistant using the order terminal 35 can confirm that the food that is already cooked is ready to be served.

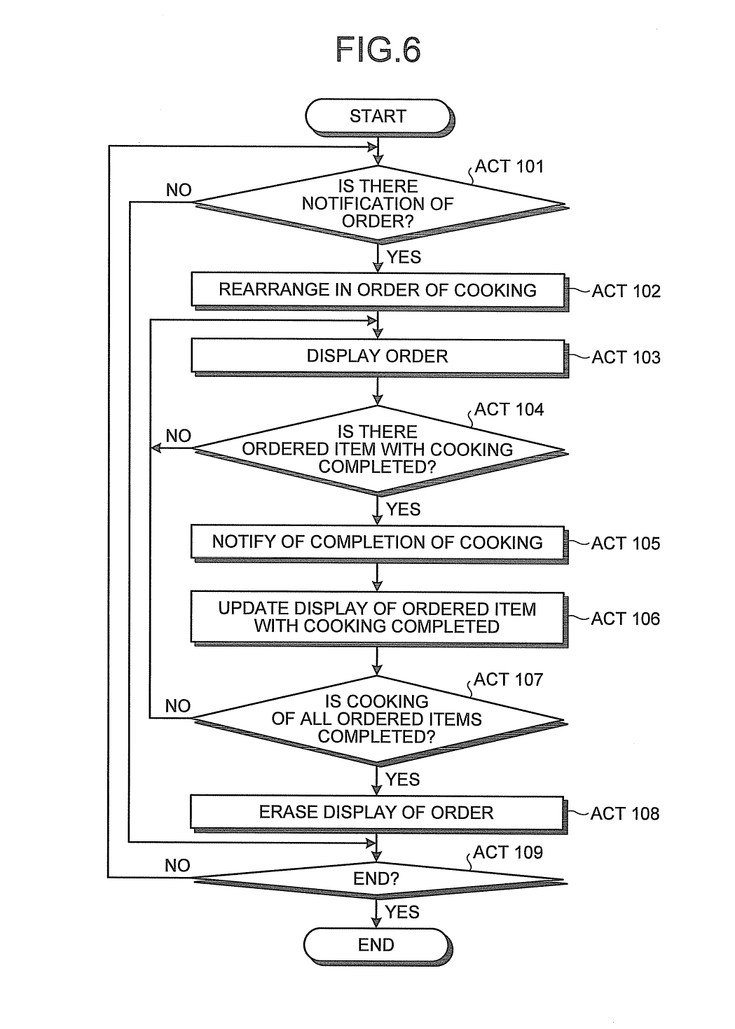

Next, the processing carried out by the wearable cooking assistance terminal 1 under the control of the control unit 121 will be described in detail with reference to FIG. 6. FIG. 6 is a flowchart showing the processing by the wearable cooking assistance terminal 1 according to this embodiment.

As shown in FIG. 6, as the processing is started, the control unit 121 determines whether there is a notification of order information from the order management server 30 or not (ACT 101). If there is no notification of order information (NO in ACT 101), the control unit 121 proceeds to the processing of ACT 109.

If there is a notification of order information (YES in ACT 101), the control unit 121 rearranges ordered items included in the order information in the order in which the ordered items should be cooked, such as appetizer, main dish, and dessert (ACT 102). Next, the control unit 121 displays the rearranged ordered items on the monitor display unit 17 (ACT 103). In ACT 102, the ordered items included in the order information may be rearranged in accordance with which category the appetizer, main dish and dessert fall in. When the wearable cooking assistance terminal 1 accepts an order, if the order in which the ordered items should be served is designated previously, the ordered items may be rearranged in that order. Thus, the cook can confirm the order in which the ordered items included in the order information should be cooked.

Next, the control unit 121 determines whether there is an ordered item with cooking completed, on the basis of the presence or absence of an input of the completion of cooking via audio operation or eye-controlled operation (ACT 104). If there is no ordered item with cooking completed (NO in ACT 104), the processing goes back to ACT 103 and the display of the ordered items included in the order information is continued.

If there is an ordered item with cooking completed (YES in ACT 104), the control unit 121 notifies the order management server 30 of the completion of cooking of the ordered item (ACT 105). Next, the control unit 121 updates the display of the order information on the monitor display unit 17 so that information indicating the completion of cooking is added with respect to that ordered item (ACT 106).

Next, the control unit 121 determines whether information indicating the completion of cooking is added to all the ordered items displayed on the monitor display unit 17 and the cooking of all the ordered items is completed or not (ACT 107). If the cooking of all the ordered items is not completed (NO in ACT 107), the control unit 121 returns to the processing of ACT 103 and continues displaying the ordered items included in the order information. If the cooking of all the ordered items is completed (YES in ACT 107), the control unit 121 erases the display of the order information on the monitor display unit 17 (ACT 108). Thus, the visibility of the wearable cooking assistance terminal 1 to the wearer 2 who is carrying out other works than the cooking of items included in the order that is accepted by the sales assistant can be improved.

Next, the control unit 121 determines whether the processing should be ended or not in accordance with a predetermined operation command or the like (ACT 109). If the processing is to be continued (NO), the processing returns to ACT 101. If the processing is to be ended (YES), the control unit 121 ends the processing as it is.

In this embodiment, the wearable cooking assistance terminal 1 that the wearer 2 wears and then uses is described as an example. However, the display and the operation configuration in the wearable cooking assistance terminal may be of a desktop type. That is, the wearable cooking assistance terminal may be a cooking assistance terminal having a display such as LCD (liquid crystal display) and an operation input unit including a touch panel and operation keys that are installed at predetermined positions. For example, the monitor display may be displayed on a display installed at a predetermined position, instead of the head mount display 10. The operation input by the user may be carried out via the touch panel and operation keys, instead of audio operation or eye-controlled operation.

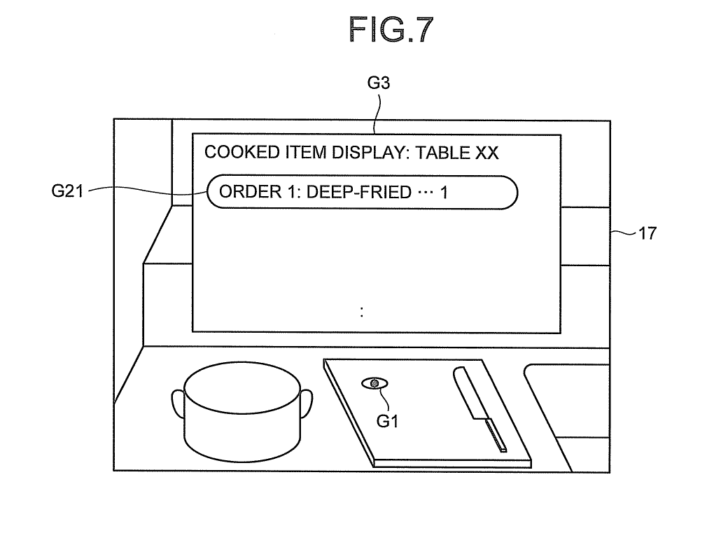

As a display layout that enables identification of ordered items with cooking completed, ordered items with cooking completed may be displayed in another display window that is different from the order display window G2. Specifically, an order icon G21 corresponding to an ordered item with cooking completed may be displayed in a cooked item display window G3 on the monitor display unit 17, as shown in FIG. 7.

The programs executed by the control unit 121 and the CPU of the order management server 30 in this embodiment may be provided by being incorporated in the ROM or the like in advance. The programs may also be provided by being recorded in a computer-readable recording medium such as CD-ROM, flexible disk (FD), CD-R or DVD, as a file in an installable or executable format.

The programs may also be provided by being stored in a computer connected to a network such as the Internet and then downloaded via the network. The program may also be provided or distributed via a network such as the Internet.

The embodiment is not limited exactly to the above-described form. In practice, components can be modified in their embodiments without departing from the scope of the invention. Various embodiments can be formed by appropriate combinations of plural components disclosed in the above embodiment. For example, some components may be deleted from all the components described in the embodiment. Moreover, components across different embodiments may be appropriately combined.

While certain embodiments have been described, these embodiments have been presented by way of example only, and are not intended to limit the scope of the inventions. Indeed, the novel terminals and methods described herein may be embodied in a variety of other forms; furthermore, various omissions, substitutions and changes in the form of the terminals and methods described herein may be made without departing from the spirit of the inventions. The accompanying claims and their equivalents are intended to cover such forms or modifications as would fall within the scope and spirit of the inventions.

What is claimed is:

1. A cooking assistance terminal comprising:
a display unit which displays a list of ordered items included in order information from a customer; and
an acceptance unit which accepts a selection command to select an ordered item with cooking completed, from the ordered items displayed in the list;
wherein the display unit displays the ordered item on which the selection command is given, identifiably from the other ordered items, as an ordered item that is already cooked.

2. The terminal according to claim 1, further comprising:
an audio pickup unit which picks up voice of a user; and
an audio recognition unit which recognizes an audio command from the user based on the picked-up voice;
wherein the acceptance unit accepts the selection command corresponding to the recognized audio command.

3. The terminal according to claim 1, further comprising a line of sight detection unit which detects a position of a line of sight of a user,
wherein the acceptance unit accepts the selection command corresponding to the position of the detected line of sight.

4. The terminal according to claim 1, wherein the display unit displays the ordered item on which the selection command is given, with an icon attached thereto indicating that the ordered item is already cooked.

5. The terminal according to claim 1, wherein the display unit displays a list of the ordered items included in the order information, the ordered items being rearranged in an order in which the ordered items should be cooked.

6. A wearable cooking assistance terminal comprising:
a head mount display which has a monitor display unit to display a list of ordered items included in order information from a customer; and
an acceptance unit which accepts a selection command to select an ordered item with cooking completed, from the ordered items displayed in the list, from a wearer of the head mount display;
wherein the monitor display unit displays the ordered item on which the selection command is given, identifiably from the other ordered items, as an ordered item that is already cooked.

7. The terminal according to claim 6, further comprising:
an audio pickup unit which picks up voice of the wearer; and
an audio recognition unit which recognizes an audio command from the wearer based on the picked-up voice;
wherein the acceptance unit accepts the selection command corresponding to the recognized audio command.

8. The terminal according to claim 6, further comprising a line of sight detection unit which detects a position of a line of sight of the wearer,
wherein the acceptance unit accepts the selection command corresponding to the position of the detected line of sight.

9. The terminal according to claim 6, wherein the monitor display unit displays the ordered item on which the selection command is given, with an icon attached thereto indicating that the ordered item is already cooked.

10. The terminal according to claim 6, wherein the monitor display unit displays a list of the ordered items included in the order information, the ordered items being rearranged in an order in which the ordered items should be cooked.

11. A method for controlling a cooking assistance terminal comprising:
displaying a list of ordered items included in order information from a customer;
accepting a selection command to select an ordered item with cooking completed, from the ordered items displayed in the list; and
displaying the ordered item on which the selection command is given, identifiably from the other ordered items, as an ordered item that is already cooked.
